(19) United States
(12) Patent Application Publication
(10) Pub. No.: US 2025/0111662 A1
(43) Pub. Date: Apr. 3, 2025

(54) METHOD AND SYSTEM FOR IDENTIFYING INFLUENTIAL TRAINING IMAGES IN DIFFUSION MODELS USING GRADIENT-BASED ATTRIBUTION

(71) Applicant: Garena Online Private Limited, Singapore (SG)

(72) Inventors: Xiaosen ZHENG, Singapore (SG); Tianyu PANG, Singapore (SG); Chao DU, Singapore (SG); Min LIN, Singapore (SG)

(21) Appl. No.: 18/898,613

(22) Filed: Sep. 26, 2024

(30) Foreign Application Priority Data
Sep. 28, 2023 (SG) 10202302771U
Sep. 25, 2024 (SG) 10202402978P

(51) Int. Cl. G06V 10/82; G06V 10/771

(52) U.S. Cl. CPC G06V 10/82; G06V 10/771

(57) ABSTRACT

The present invention provides solutions for identifying influential training images in diffusion models by calculating importance scores through gradient-based attribution. The system uses a novel Diffusion-Tracing with the Randomly projected After Kernel (D-TRAK) method for identifying and scoring the influence of individual training data points on the outputs of diffusion models, thereby enabling the accurate and interpretable attribution of data in generative models. This approach allows for the identification of training images that have a significant positive or negative influence on a specific generated output image. By focusing on the final checkpoint data, the system reduces computational costs while providing accurate attribution of image generation results. This invention has applications in copyright protection, and model transparency, particularly in identifying the contribution of specific training data to generated outputs.

### CROSS REFERENCE TO RELATED APPLICATIONS

This patent application claims the benefit and priority of Provisional Singaporean patent application number 10202302771U filed with the Intellectual property Office of Singapore on Sep. 28, 2023 entitled “DATA ATTRIBUTION FOR DIFFUSION MODELS,” and of Singaporean patent application number 10202402978P, filed with the Intellectual property Office of Singapore on Sep. 25, 2024, entitled “METHOD AND SYSTEM FOR IDENTIFYING INFLUENTIAL TRAINING IMAGES IN DIFFUSION MODELS USING GRADIENT-BASED ATTRIBUTION,” the contents of which are incorporated by reference in their entireties.

### TECHNICAL FIELD

The present invention generally relates to a method and system for data attribution and, more particularly relates to a method and system for identifying influential training images in diffusion models using gradient-based attribution.

### BACKGROUND

Diffusion models have become powerful tools for generating high-quality outputs, such as images and videos. These models work by progressively refining noisy images over multiple steps, resulting in high-quality outputs. However, as these models are increasingly used in various applications, it is important to understand the influence of individual training images on the generated output. Traditional methods for data attribution struggle with the complexity and multi-step nature of diffusion processes.

Data attribution in diffusion models is challenging due to the complex, iterative nature of the diffusion process. Each step in the process contributes to the final output, making it difficult to trace the influence of individual training data points.

To address potential issue of identifying the attribution for the generated output, there is a clear need to improve the method of data attribution within the diffusion model.

Furthermore, other desirable features and characteristics will become apparent from the subsequent detailed description and the appended claims, taken in conjunction with the accompanying drawings and this background of the disclosure.

### SUMMARY OF THE INVENTION

In accordance with one aspect of the present invention, there is provided a method identifying an influential training image in a diffusion model for image generation, comprising the steps of: training the diffusion model using a set of training images; generating one or more output images using the trained diffusion model; computing a gradient matrix for each image in the set of training images; calculating an importance score for the each image in the set of training images based on the computed gradient matrix, wherein the importance score indicates an importance of the set of training images to the one or more output image; and identifying one or more of the training images as the influential training image when the importance score exceeds a predetermined threshold.

In some embodiments, the importance score is τ_{D-TRAK}, and is calculated based on the equation of

$${τ}_{D - TRAK} ( x , 𝒟 ) = [ \frac{1}{S} {\sum }_{S = 1}^{S} {{ϕ}^{s} ( x )}^{⊤} {( {Φ}_{D - TRAK}^{{s}^{⊤}} {Φ}_{D - TRAK}^{s} )}^{- 1} {Φ}_{D - TRAK}^{{s}^{⊤}} ]$$

wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}^{s}=[ϕ^{s}(x¹); . . . ; ϕ^{s}(x^{N})]^{T}, which is the gradient matrix.

In some embodiments, wherein ϕ^{s}(x)=∇_{θ} [symbol] (x, θₛ*), and function [symbol] comprising any one of [symbol] _{square}, [symbol] _{Avg} or [symbol] ₚ₋ₙₒᵣₘ, wherein:

$$\begin{matrix}a . & \\ {ℒ}_{square} ( x , θ ) = {E}_{t , ϵ ,} [ {‖ {ϵ}_{θ} ( {x}_{t} , t ) ‖}_{2}^{2} ] ; & \end{matrix}$$

$$\begin{matrix}b . & \\ {ℒ}_{Avg} ( x , θ ) = {E}_{t , ϵ ,} [ Avg ( {ϵ}_{θ} ( {x}_{t} , t ) ) ] ; & \end{matrix}$$

$$\begin{matrix}c . & \\ {ℒ}_{p - norm} ( x , θ ) = {E}_{t , ϵ ,} [ {‖ {ϵ}_{θ} ( {x}_{t} , t ) ‖}_{p} ] ; & \end{matrix}$$

wherein

$${x}_{t} = \sqrt{{\overline{α}}_{t}} x + \sqrt{1 - {\overline{α}}_{t}} ,$$

ϵ and Avg is an average pooling operation.

In some embodiments, the gradient matrix computation is performed at different training data checkpoints.

In some embodiments, the method further comprises identifying training data checkpoints that contributed most to the generated one or more output images.

In some embodiments, the gradient matrix computation is performed at a final checkpoint.

In some embodiments, the diffusion model is a Denoising Diffusion Probabilistic Model (DDPM) or a Latent Diffusion Model (LDM).

In some embodiments, the method further comprises ranking the set of training images based on their importance scores to identify most important images.

In some embodiments, the method further comprises a verification step, which comprises: retraining the diffusion model after excluding the most important images identified in the ranking process; generating images using the retrained model; and measuring a pixel wise l₂ distance or Contrastive Language-Image Pre-training (CLIP) cosine similarity between images generated by the original and retrained models to confirm an influence of the removed most important images.

In some embodiments, positive importance scores identify proponent images, and negative scores identify opponent images among the set of training images.

In some embodiments, the method further comprises displaying the identified influential image and/or its corresponding influence score.

In some embodiments, the method further comprises removing training images with low importance score, where the low importance score is below the predetermined threshold value; finetuning or retraining the diffusion model after removing the training images with low importance score.

In some embodiments, the method further comprises regenerating the one or more output image using the retrained diffusion model.

In accordance with another aspect of the present invention, there is provided a system of identifying an influential training image in a diffusion model for image generation, comprising: a processor; a memory in electronic communication with the processor; and instructions stored in the memory and executable by the processor to cause the system to: training the diffusion model using a set of training images; generating one or more output images using the trained diffusion model; computing a gradient matrix for each image in the set of training images; calculating an importance score for the each image in the set of training images based on the computed gradient matrix, wherein the importance score indicates an importance of the set of training images to the one or more output image; and identifying one or more of the training images as the influential training image when the importance score exceeds a predetermined threshold.

In some embodiments, the importance score is τ_{D-TRAK}, and is calculated based on the equation of

$${τ}_{D - TRAK} ( x , 𝒟 ) = [ \frac{1}{S} {\sum }_{S = 1}^{S} {{ϕ}^{s} ( x )}^{⊤} {( {Φ}_{D - TRAK}^{{s}^{⊤}} {Φ}_{D - TRAK}^{s} )}^{- 1} {Φ}_{D - TRAK}^{{s}^{⊤}} ]$$

wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}=[ϕ^{s}(x¹); . . . ; ϕ^{s}(x^{N})]^{T}, which is the gradient matrix.

In some embodiments, wherein ϕ^{s}(x)=∇_{θ} [symbol] (x, θₛ*), and function [symbol] comprising any one of [symbol] _{square}, [symbol] _{Avg} or [symbol] ₚ₋ₙₒᵣₘ, wherein:

$$\begin{matrix}a . & \\ {ℒ}_{square} ( x , θ ) = {E}_{t , ϵ ,} [ {‖ {ϵ}_{θ} ( {x}_{t} , t ) ‖}_{2}^{2} ] ; & \end{matrix}$$

$$\begin{matrix}b . & \\ {ℒ}_{Avg} ( x , θ ) = {E}_{t , ϵ ,} [ Avg ( {ϵ}_{θ} ( {x}_{t} , t ) ) ] ; & \end{matrix}$$

$$\begin{matrix}c . & \\ {ℒ}_{p - norm} ( x , θ ) = {E}_{t , ϵ ,} [ {‖ {ϵ}_{θ} ( {x}_{t} , t ) ‖}_{p} ] ; & \end{matrix}$$

d, wherein

$${x}_{t} = \sqrt{{\overline{α}}_{t}} x + \sqrt{1 - {\overline{α}}_{t}} ,$$

ϵ and Avg is an average pooling operation.

In some embodiments, the gradient matrix computation is performed at different training data checkpoints.

In some embodiments, the gradient matrix computation is performed at a final checkpoint.

In some embodiments, the system further comprises displaying the identified influential training image and/or its corresponding influence score.

In accordance with another aspect of the present invention, there is provided an apparatus of identifying an influential training image in a diffusion model for image generation, comprising: means for training the diffusion model using a set of training images; means for generating one or more output images using the trained diffusion model; means for computing a gradient matrix for each image in the set of training images; means for calculating an importance score for the each image in the set of training images based on the computed gradient matrix, wherein the importance score indicates an importance of the set of training images to the one or more output image; and means for identifying one or more of the training images as the influential training image when the importance score exceeds a predetermined threshold.

In accordance with another aspect of the present invention, there is provided a computer-readable storage medium, on which a computer program is stored, wherein the computer program, when executed in a computer, causes the computer to perform the method of any one of the methods discussed hereinabove.

It should be understood that the embodiments described herein are not exhaustive and that additional features and variations of the invention may be incorporated. Various other advantages and novel features of the invention will become apparent from the following detailed description when considered in conjunction with the accompanying drawings.

The various embodiments are not necessarily mutually exclusive, as some embodiments can be combined with one or more other embodiments to form new embodiments. Embodiments described in the context of one of the systems or methods are analogously valid for the other systems or methods. Similarly, embodiments described in the context of a method are analogously valid for a system, an apparatus or a computer program, and vice-versa.

Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

### BRIEF DESCRIPTION OF THE DRAWINGS

The disclosure will be better understood with reference to the detailed description when considered in conjunction with the non-limiting examples and the accompanying drawings, in which:

FIG. 1 is a system for identifying the influential training images in diffusion models according to an embodiment of the invention.

FIG. 2 is a block diagram of an electronic device for identifying the influential training images according to an embodiment of the invention.

FIG. 3 is a flowchart of a method for identifying the influential training images in diffusion models according to an embodiment of the invention.

FIG. 4 a flowchart of a method for utilizing data attribution in diffusion models to create counterfactual scenarios.

FIG. 5a is a table of Latent Diffusion Score (LDS) values using the data attribution method according to an embodiment of the invention.

FIG. 5b is the Latent Diffusion Score (LDS) values on the generation set of CIFAR-2 using checkpoints of different epochs using the data attribution method according to an embodiment of the invention.

FIG. 6 is the boxplots of counterfactual evaluation on CIFAR-2 and ArtBench-2 using the data attribution method according to an embodiment of the invention.

FIG. 7 is the counterfactual visualization on (7a, 7b) ArtBench-2 using the data attribution method according to an embodiment of the invention.

### DETAILED DESCRIPTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the spirit or scope of the subject matter presented herein. Unless specified otherwise, the terms “comprising”, “comprise”, “including” and “include” used herein, and grammatical variants thereof, are intended to represent “open” or “inclusive” language such that they include recited elements but also permit inclusion of additional, un-recited elements.

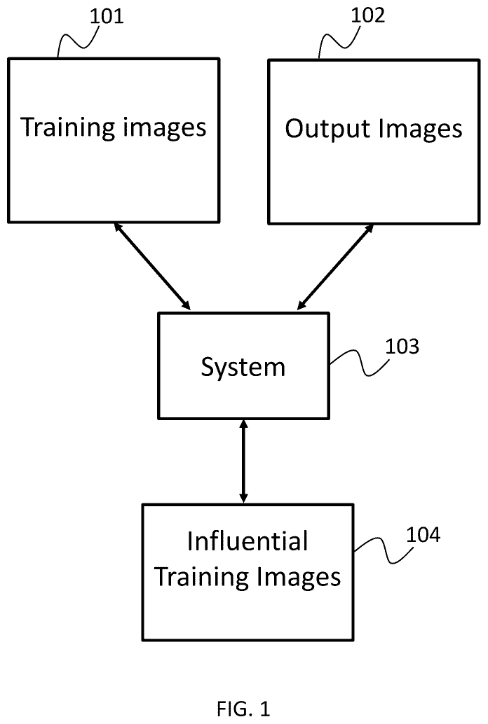

FIG. 1 is a system for identifying influential training images in diffusion models according to an embodiment of the invention.

In the context of generative models, such as diffusion models, it is crucial to accurately attribute the generated images to the corresponding training images. This attribution serves the purpose of appropriately assigning credits or valuations, as well as safeguarding copyright.

This architecture diagram outlines a system designed to identify the most influential training images in diffusion models used for image generation. The system traces the model outputs back to the training data, determining which inputs have the most significant impact on the generated output images.

The system 103 receives the input training images 101. The input images are supplied to the diffusion model of the system 103. The diffusion model of the system 103 generates output images 102.

The data attribution module of the system 103 calculates gradients, assigns importance scores, and/or ranks the training images 101 based on their influence on the output image 102. The influential training images 104 are identified after the data attribution.

The system 103 further refines the training image dataset 101 based on the analysis of influential training images and prepares it for potential retraining.

It should be understood by a person skilled in the art that the described invention is applicable to various types of images, including but not limited to static images, video etc. The scope of the invention should not be constrained by the specific examples provided but should encompass all variations and adaptations that fall within the broader principles and innovative aspects described.

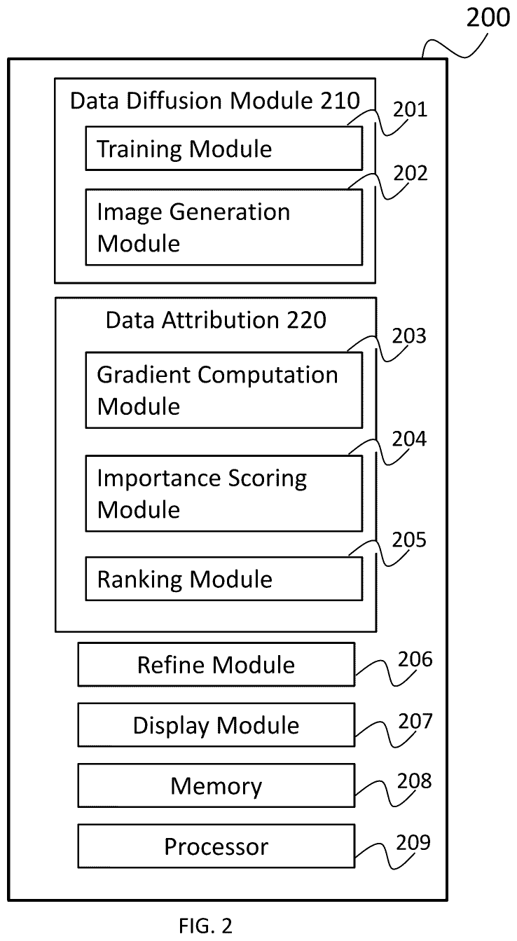

FIG. 2 is a block diagram of an electronic device for identifying the influential training images according to an embodiment of the invention.

In accordance with an example embodiment, the system 200 may include a data diffusion module 210, a data attribution module 220, a refine module 206, a display module 207, one or more memories 208 and one or more processors 209.

The data diffusion module 210 further comprises a data training module 201 and an image generation module 202. The diffusion model 210 takes the input training images and processes them through a series of diffusion steps to generate the final output image.

The data training module 201 is responsible for collecting and preprocessing the input training images. These images serve as the foundational data used by the diffusion model 210. The input training images are prepared and collected to the diffusion model 210 for processing.

In some embodiments, in the preprocessing step for image generation, the input images are prepared to ensure consistency and quality, which is vital for the effectiveness of the diffusion model. This process typically involves normalizing the images to a uniform scale, resizing them to match the model's input requirements, and applying data augmentation techniques such as flipping, rotating, or color adjustments to enhance the model's ability to generalize from the data. This thorough preprocessing ensures that the diffusion model starts with well-prepared data, leading to better and more reliable output images.

The image generation module 202 is the module that generates images using the diffusion model, either the original or the retrained one. This is the core model responsible for generating the output images from the input training images of the diffusion model. The diffusion model might be a Denoising Diffusion Probabilistic Model (DDPM) or any other similar model designed to generate images.

After generating the output image, the output image is then passed to either the user and/or the data attribution module 220.

The data attribution module 220 is central to identifying the most influential training images. It traces the generated output image back to the training data to determine which images had the most significant impact. It includes a gradient computation module 203, an importance score module 204 and/or a ranking module 205.

Gradient computation module 203 is the module that computes gradient values for each training image. These gradients represent how sensitive the output image is to changes in the training image.

In some embodiments, the gradient computation is implemented using a faster custom CUDA kernel. A custom CUDA kernel is a piece of code written specifically for NVIDIA GPUs to perform certain computations more efficiently. By writing a custom CUDA kernel, developers can directly control the GPU hardware, optimizing the execution of specific tasks to maximize performance. This can result in significantly faster computation compared to using pre-built functions.

For importance score calculation module 204, it calculates an importance score for each training image based on the computed gradients. It determines if the image has a high importance score above a certain threshold. Images with importance scores above a certain threshold are considered highly influential.

In some embodiments, the system 200 further comprises a ranking module 205, it ranks the training images based on their importance scores to identify the most influential images. This module outputs a list of ranked training images based on their importance scores.

The data refine module 206, this module manages the training data based on the feedback from the data attribution module 220. It may involve retraining the model by removing or emphasizing certain training images based on their importance scores.

The refined training data can be sent back to the data attribution model 220 for further iterations or sent to the data diffusion module 210 to generate the images.

Display module 207 displays the final output images generated by the diffusion module.

In some embodiments, the importance scores of the input training images are also displayed together with the input training images.

In some embodiments, the system includes a memory 208. It stores the training images along with their importance scores for further analysis or future use. The memory 208 may include one or more non-transitory computer-readable storage media that may be non-transitory. The memory 208 may further include a high-speed random access memory and a non-volatile memory, such as one or more magnetic disk storage devices or flash storage devices. In some embodiments, a non-transitory computer-readable storage medium in the memory 208 is configured to store at least one piece of program code, the at least one piece of program code being configured to be executed by the processor 209 to implement the data diffusion and data attribution provided in the method embodiments of the invention.

In some embodiments, the user equipment includes a processor 209. The processor 209 can be implemented using various technologies and architectures designed to fulfil the described functions. It may be realized as a general-purpose processor, content addressable memory, digital signal processor, application-specific integrated circuit, field-programmable gate array, programmable logic device, discrete gate or transistor logic, discrete hardware components, or a combination thereof. Additionally, a processor can take the form of a microprocessor, controller, microcontroller, or state machine.

Furthermore, the processor 209 may be realized through a combination of computing devices, such as combining a digital signal processor with a microprocessor, utilizing multiple microprocessors, integrating one or more microprocessors with a digital signal processor core, or employing any other suitable configuration.

In some embodiments, the processor 209 has 64 CPU cores and NVIDIA A100 GPUs each with 40 GB of memory.

A person skilled in the art will recognize that the structure depicted in FIG. 2 is not limited to system 200. The system may include additional or fewer components than those illustrated, some components may be combined, or alternative component configurations may be employed.

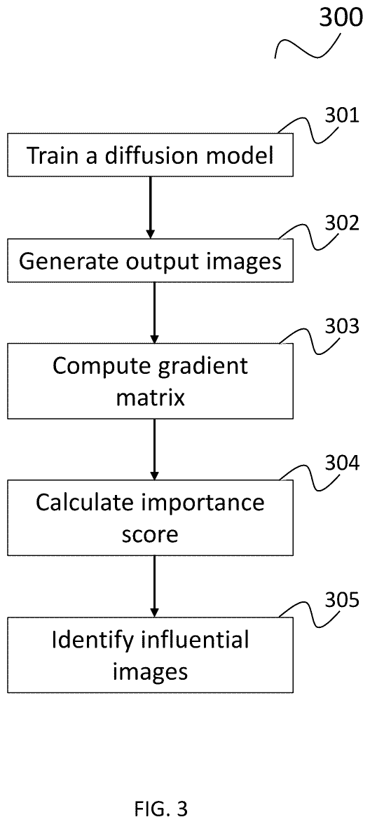

FIG. 3 is a flowchart of a method for identifying the influential training images in diffusion models according to an embodiment of the invention. As a preliminary matter, it should be understood that steps of the method 300 are not necessarily limiting, and that steps can be added, omitted, and/or performed simultaneously without departing from the scope of the appended claims. It should be appreciated that the method 300 may include any number of additional or alternative tasks and that the method 300 may be incorporated into a more comprehensive procedure or process having additional functionality not described in detail herein. Moreover, one or more of the tasks shown in FIG. 3 could be omitted from an embodiment of the method 300 as long as the intended overall functionality remains intact. It should also be understood that the illustrated method 300 can be stopped at any time. The method 300 is computer-implemented in that various tasks or steps that are performed in connection with the method 300 may be performed by software, hardware, firmware, or any combination thereof.

The present invention primarily focuses on discrete-time diffusion models, specifically DDPMs and latent diffusion models (LDMs) that serve as the foundation of Stable Diffusion.

Data attribution in diffusion models is challenging due to the complex, iterative nature of the diffusion process. Each step in the process contributes to the final output, therefore attributing the generated images back to specific training data is challenging because each step in the diffusion process subtly alters the image, and the cumulative effect makes it difficult to trace the origin of specific image features. The current invention is related to a data attribution method to track the influence of the training data more accurately called Diffusion-Tracing with the Randomly projected After Kernel (D-TRAK).

The D-TRAK method is designed to tackle these challenges by focusing on each step in the diffusion process and quantifying the influence of each training image on the final generated output. The D-TRAK method addresses these challenges by decomposing the diffusion process into individual steps and attributing the output of each step to specific training data points. The method involves the following key steps:

At step 301, it trains the diffusion model. It gathers the input training data and trains the diffusion model using the collected data. During training, the model learns to map noisy inputs to their original, noise-free forms, thereby generating realistic outputs such as images or videos.

At step 302, it generates the output images based in the input training images by the diffusion model. Diffusion models, such as DDPMs, generate images by iteratively refining noisy images. The process begins with an initial noise image and gradually denoises it through a series of steps until a high-quality image is produced. The process involves multiple steps, each adding or removing noise, leading to a final generated output.

At step 303, it computes the gradient for each training image to assess its influence on the generated output for each data checkpoint. To understand the influence of each training image on the generated output, it computes the gradient of the output image concerning each training input. The gradient indicates how much a small change in a training image would affect the generated output. The importance of a training image is then determined by the magnitude and direction of this gradient.

At step 304, it calculates the importance score of the input training image. In some embodiment, if the importance score assigned to a training image exceeds a certain threshold value, such as zero, it is classified as an important image. Each training image is assigned an importance score, where positive scores indicate proponents, and negative scores indicate opponents. The importance score for each training image is calculated to reflect its influence on the output image. Positive scores (proponents) signify that the training image supports or contributes positively to the generation of the output image, whereas negative scores (opponents) signify that the training image opposes or detracts from the generation of the output image.

It should be understood by a person skilled in the art that the threshold value for determining the important image can be set to different levels based on the specific requirements and objectives of the method. The techniques and methods disclosed herein are not limited to a fixed threshold and can be adapted to accommodate varying thresholds as needed to optimize performance for different applications.

At step 305, the method identifies the top influential images based on their importance scores, providing valuable insights for model interpretability and data management. Based on the calculated importance scores, it identifies the top training images that have the most significant influence on the generated output. This identification process is crucial for understanding model behavior, enhancing interpretability, and managing the ethical implications of machine generated content.

In some embodiments, the diffusion process is broken down into individual steps or different data checkpoints, each of which is analyzed separately. The computation of the gradient matrix is performed at different training data points to evaluate their contribution to the generated output images. The influence of each training data check point is measured using gradient-based methods, allowing for fine-grained attribution at each step. An importance score is calculated for each training data checkpoint, reflecting its contribution to the final output. It is crucial for identifying which training data checkpoints have the most significant influence on the output of the diffusion model. By analyzing the gradient matrix at these different points, the method allows for a more granular understanding of how each data point affects the overall model performance.

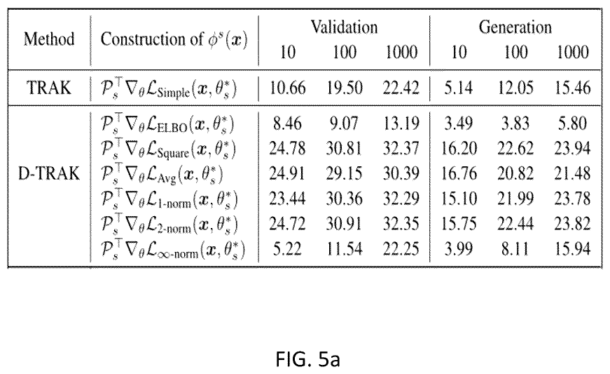

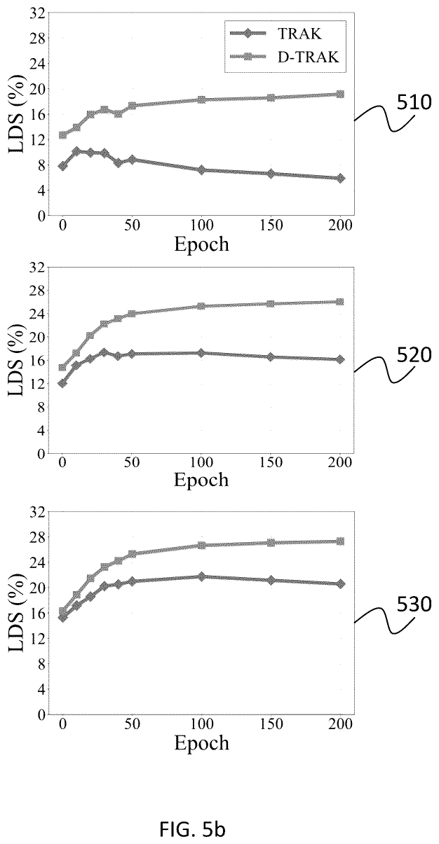

In some embodiments, the method focuses on the final checkpoint data. To reduce computational costs, the method focuses on the final checkpoint data, which represents the state of the model after training has converged. By analyzing the final checkpoint, the method provides accurate attribution results without the need for repeated computations across all training steps. As shown in FIG. 5b, the final checkpoint consistently achieves the best performance when using the D-TRAK method. Hence, by focusing on final checkpoint data, the method reduces computational overhead while maintaining accurate attribution.

In some embodiments, the step of data attribution can also be used to optimize diffusion models by identifying which parts of the data are contributing positively or negatively to the final output. This insight can help in finetuning the model or debugging issues related to poor generation quality.

In some embodiments, the diffusion model is finetuned by identifying and removing training images with low importance scores. The importance score is calculated for each training image, and those images with scores below the predetermined threshold value are considered to have minimal influence on the desired output. By removing these low-scoring images from the training dataset, the diffusion model is retrained, allowing for a refined adjustment that optimizes the model's ability to generate more relevant and accurate outputs.

In some embodiments, the output image is regenerated after the removal of low-importance training images. Once these low-scoring images are excluded from the training dataset, the diffusion model undergoes a retraining process. Following this retraining, new output images are generated, resulting in a more optimized and targeted generation process.

Therefore, for the current invention, it provides clear identification of training images that influence the generated output, crucial for image generation transparency and accountability. It offers a robust method for identifying influential training images in diffusion models, particularly for image generation tasks. By leveraging gradient-based attribution and importance scoring, it provides a transparent and cost-effective approach to understanding and managing the impact of training data on machine generated content.

This invention has significant implications for fields like artificial intelligence (AI) ethics, copyright protection, and model interpretability, as it enhances the ability to trace and assign credit to the specific data used in generating AI outputs. The invention could be particularly valuable in ensuring that contributors to large datasets are appropriately compensated or credited, especially when the data is used to generate high-value or copyrighted content.

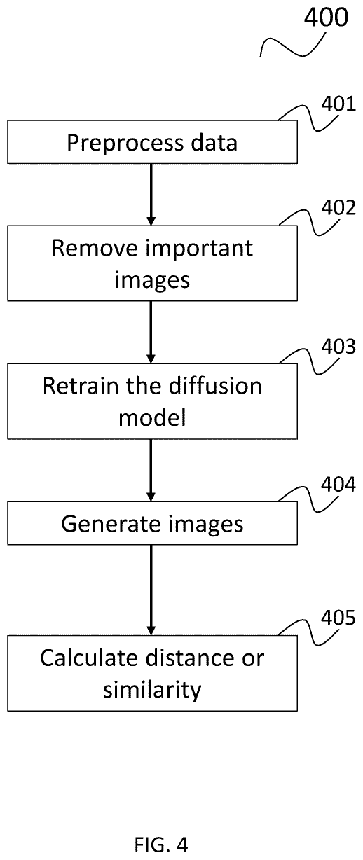

FIG. 4 a flowchart of a method for utilizing data attribution in diffusion models to create counterfactual scenarios.

Similar to other machine learning models, data attribution in diffusion models can be used to create counterfactual scenarios. For example, by tweaking certain inputs and observing changes in the output, one can understand the model's sensitivity to specific data points, leading to better model robustness. The method of creating the counterfactual scenarios involves the following key steps.

At step 401, in some embodiment, the training dataset is preprocessed to prepare it for analysis. This may involve standard data augmentation techniques, normalization, and other preprocessing methods to ensure that the data is suitable for training and evaluation.

At step 402, it removes the important images identified in FIG. 3. After the importance of each image is quantified, it allows the identification of the most important images that have a significant impact on the diffusion model's output. The identified most important images are removed from the training dataset.

At step 403, the diffusion model is then retrained using the modified dataset, which excludes the top-ranking influential images. This step is critical in creating a counterfactual scenario, as it allows the analysis of how the absence of these important images affects the model's performance.

At step 404, after the retraining, the modified diffusion model is used to generate new images. These images represent the counterfactual scenario, where the influence of the most important training images has been removed.

At step 405, the impact of the removed training images is evaluated by comparing the images generated by the original model with those generated by the retrained model. This comparison is performed using pixel-wise 2 distance metrics and Contrastive Language-Image Pre-training (CLIP) cosine similarity. These metrics provide quantitative measures of how the removal of the most important images has influenced the generated outputs, confirming their significance in the original model. A large pixel-wise l₂ distance metric indicates that the regenerated image is significantly different from the input image after excluding the top influential training examples. Similarly, a low CLIP cosine similarity score reflects the same effect, showing that the regenerated image has diverged substantially from the original image due to the removal of these influential examples.

Therefore, by identifying and potentially removing the influential images to create the create counterfactual scenarios, the method allows for the refinement of training datasets, leading to improved model performance.

### EXAMPLES

The system and method herein disclosed are further illustrated in the following examples, which are provided by way of illustration and are not intended to be limiting the scope of the present disclosure.

### Diffusion Models

In one embodiment, the diffusion model is the DDPMs. The details of the DDPM are as follows: DDPMs process define a random variable [symbol] ∈ [symbol] and define a forward diffusion process on [symbol] as [symbol] _{1:T} [symbol] [symbol] ₁, . . . , [symbol] _{T} with T∈ [symbol] ⁺. The data distribution is [symbol] ˜q( [symbol] ) and the Markov transition probability from [symbol] ₜ₋₁ to [symbol] ₜ is q( [symbol] ₜ| [symbol] ₜ₋₁) [symbol] [symbol] ( [symbol] ₜ|\sqrt{1−βₜ} [symbol] ₜ₋₁, βₜI), where [symbol] ₀= [symbol] and β₁, . . . , β_{T} correspond to a variance schedule. A notable property of DDPMs is that they can sample at [symbol] ₜ an arbitrary timestep t directly from [symbol] , since there is

$$q ( {x}_{t} \vert x ) = 𝒩 ( {x}_{t} \vert \sqrt{{\overline{α}}_{t}} x , ( 1 - {\overline{α}}_{t} ) I ) ,$$

where αₜ [symbol] 1−βₜ and α̅ₜ [symbol] Πᵢ₌₁^{t} αᵢ. In some embodiment, when βₜ are small, the reverse diffusion process can also be modeled by Gaussian conditionals.

Specifically, for the DDPMs framework, the reverse transition probability from [symbol] ₜ to [symbol] ₜ₋₁ is written as p₀( [symbol] ₜ₋₁| [symbol] ₜ)= [symbol] ( [symbol] ₜ₋₁|μ_{θ}( [symbol] ₜ, t), σₜ²I), where θ∈ [symbol] ^{d} is the model parameters and σₜ are time dependent constants that can be predefined or analytically computed. Instead of directly modeling the data prediction μ_{θ}, DDPMs choose to model the noise prediction ϵ_{θ} based on the parameterization

$${μ}_{θ} ( {x}_{t} , t ) = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) ) .$$

The training objective of ϵ_{θ}( [symbol] ) can be derived from optimizing the variational bound of negative log-likelihood formulated as follows:

$${ℒ}_{ELBO} ( x ; θ ) = {ϵ , t}_{} [ \frac{{β}_{t}^{2}}{2 {σ}_{t}^{2} {α}_{t} ( 1 - {\overline{α}}_{t} )} {‖ ϵ - {ϵ}_{θ} ( \sqrt{{\overline{α}}_{t}} x + \sqrt{1 - {\overline{α}}_{t}} ϵ , t ) ‖}_{2}^{2} ] , \qquad ( 1 )$$

where ϵ˜ [symbol] (ϵ|0, I) and t˜ [symbol] ([1, T]) denotes the discrete uniform distribution between 1 and T. Let [symbol] [symbol] { [symbol] ⁿ}ₙ₌₁^{N} be a training dataset that [symbol] ⁿ˜q( [symbol] ), then the empirical training objective on [symbol] can be written as

$${ℒ}_{ELBO} ( 𝒟 ; θ ) = \frac{1}{N} {\sum }_{{x}^{n} ∈ 𝒟} {ℒ}_{ELBO} ( {x}^{n} , θ ) .$$

To benefit sample quality, DDPMs apply a simplified training objective that corresponds to a weighted variational bound and is formulated as

$${ℒ}_{simple} ( x ; θ ) = {𝔼}_{ϵ , t} [ {‖ ϵ - {ϵ}_{θ} ( \sqrt{{\overline{α}}_{t}} x + \sqrt{1 - {\overline{α}}_{t}} ϵ , t , ) ‖}_{2}^{2} ] , \qquad ( 2 )$$

where the empirical objective on [symbol] is similarly written as

$${ℒ}_{Simple} ( 𝒟 ; θ ) = \frac{1}{N} {\sum }_{{x}^{n} ∈ D} {ℒ}_{Simple} ( {x}^{n} , θ ) .$$

### Data Attribution and Evaluation Metrics:

Data attribution refers to the goal of tracing model outputs back to training data. Consider an ordered training set of samples [symbol] [symbol] { [symbol] ⁿ}ₙ₌₁^{N} and a model output function [symbol] ( [symbol] ; θ). A data attribution method τ( [symbol] , [symbol] ) is a function τ: [symbol] × [symbol] ^{N}→ [symbol] ^{N} that, for any sample [symbol] ∈ [symbol] and a training set [symbol] , assigns a score to each training input [symbol] ⁿ∈ [symbol] indicating its importance to the model output [symbol] ( [symbol] ; θ*( [symbol] ), where θ*( [symbol] )=arg min_{θ} [symbol] ( [symbol] ; θ).

In some embodiments, the linear data modeling score (LDS) is used to evaluate data attribution, which considers the sum of attributions as an additive proxy for [symbol] , as a metric for evaluating data attribution methods. It is noted that there are various other metrics to evaluate data attribution methods, including but not limited to leave-one-out influences, Shapley values, and performance on auxiliary tasks. This score is a direct measure of the influence that each training image has on the final output image. A higher score indicates that the corresponding training image plays a more critical role in shaping the characteristics and quality of the generated image, making it a key contributor to the model's performance.

For the LDS evaluation method, it defines the attribution-based output prediction of the model output [symbol] ( [symbol] ; θ*( [symbol] ′)) as

$${g}_{τ} ( x , {𝒟}^{′} ; 𝒟 ) {=}^{Δ} {\sum }_{{x}^{n} ∈ {𝒟}^{′}} {τ ( x , 𝒟 )}_{n} , \qquad ( 3 )$$

where [symbol] ′ is a subset of [symbol] as [symbol] ′⊂ [symbol] . Then the LDS metric can be constructed as follows:

Considering a training set [symbol] , a model output function [symbol] ( [symbol] ; θ), and a corresponding data attribution method τ. Let { [symbol] ^{m}}ₘ₌₁^{M} be M randomly sampled subsets of the training dataset [symbol] that [symbol] ^{m}⊂ [symbol] , each of size α·N for some α∈(0, 1). The linear data modeling score (LDS) of a data attribution τ for a specific sample [symbol] ∈ [symbol] is given by

$$LDS ( τ , x ) {=}^{Δ} ρ ( \{ ℱ ( x ; {θ}^{*} ( {𝒟}^{m} ) ) : m ∈ [ M ] \} , \{ {g}_{τ} ( x , {𝒟}^{m} , 𝒟 ) : m ∈ [ M ] \} ) , \qquad ( 4 )$$

where ρ denotes Spearman rank correlation.

In some embodiments, to counter the randomness of the training mechanism (the process of approximating θ*( [symbol] ^{m})), for every subset [symbol] ^{m}, it trains three models with different random seeds and average the model output function. It reduces variance in the model's performance.

In some embodiments, a counterfactual evaluation approach is used to assess the utility of the data attribution methods. it compares the pixel-wise [symbol] ₂-distance and CLIP cosine similarity of generated images, using the models trained before/after the exclusion of the highest-ranking positive influencers identified by different attribution methods. Specifically, the approach comprises the steps of retraining the models after selectively removing training images identified as the highest-ranking positive influencers; comparing the pixel-wise l₂-distance between images generated by the original and retrained models to quantify the impact of excluding influential training examples; evaluating the CLIP cosine similarity between images generated by the original and retrained models to quantify the impact of excluding influential training examples.

This process ensures that the attribution methods are thoroughly evaluated in terms of their ability to accurately identify and rank the most influential training examples that affect the output of the diffusion model.

### Attribution Methods:

Tracing with the Randomly Projected after Kernel (TRAK)

In some embodiments, the data attribution is implemented using the method of TRAK. The primary interface employed by attribution methods is the score τ( [symbol] , [symbol] ), which is calculated for each training input to indicate its importance to the output of interest. The influence functions are a classical concept that approximates how much an infinitesimally up-weighting of a training sample [symbol] ⁿ∈ [symbol] affects the model output function [symbol] ( [symbol] ; θ*), measured on a sample of interest [symbol] . In the convex setting, the attributing score of influence function can be computed as τ_{IF}( [symbol] , [symbol] )ₙ=∇_{θ} [symbol] ( [symbol] ; θ*)^{T}· [symbol] _{θ*}⁻¹·∇_{θ} [symbol] ( [symbol] ⁿ; θ*) for [symbol] ∈[N], where [symbol] _{θ*}=∇_{θ}² [symbol] ( [symbol] ; θ*) is the Hessian matrix at the optimal parameters θ*.

TRAK aims to enhance the efficiency and scalability of attributing discriminative classifiers. In the TRAK algorithm, a total of S subsets denoted as { [symbol] ^{s}}ₛ₌₁^{S} are initially sampled from the training dataset [symbol] , where each subset has a fixed size of β·N for β∈(0, 1] On each subset [symbol] ^{s}, a model is trained to obtain the parameters θₛ*∈ [symbol] ^{d} and a random projection matrix [symbol] ₛ is sampled from [symbol] (0, 1)^{d×k} (typically there is [symbol] <<d). Then TRAK constructs the projected gradient matrices Φ_{TRAK}^{s} and the weighting terms [symbol] _{TRAK}^{s} as

$${Φ}_{TRAK}^{s} = {[ {ϕ}^{s} ( {x}^{1} ) ; … ; {ϕ}^{s} ( {x}^{N} ) ]}^{T} , where {ϕ}^{s} ( x ) = {𝒫}_{s}^{T} {∇}_{θ} ℱ ( x ; {θ}_{s}^{*} ) ; \\ {𝒬}_{TRAK}^{s} = diag ( {Q}^{s} ( {x}^{1} ) , … , {Q}^{s} ( {x}^{N} ) ) , where {Q}^{s} ( x ) = \frac{\partial ℒ}{\partial ℱ} ( x ; {θ}_{s}^{*} ) . \qquad ( 5 )$$

Finally, the attribution score τ_{TRAK}( [symbol] , [symbol] ) of TRAK is computed by

$${τ}_{TRAK} ( x , 𝒟 ) = [ \frac{1}{S} {\sum }_{s = 1}^{S} {{ϕ}^{s} ( x )}^{T} {( {{Φ}_{TRAK}^{s}}^{T} {Φ}_{TRAK}^{s} )}^{- 1} {{Φ}_{TRAK}^{s}}^{T} ] [ \frac{1}{S} {\sum }_{s = 1}^{S} {𝒬}_{TRAK}^{s} ] . \qquad ( 6 )$$

In the discriminative classification cases, the model output function is [symbol] ( [symbol] ; θ)=log (exp( [symbol] ( [symbol] ; θ))−1) according to the mechanism of logistic regression.

Diffusion-Tracing with the Randomly Projected after Kernel (D-TRAK)

In some embodiments, the data attribution is implemented using the method of D-TRAK.

Given a DDPM trained by minimizing [symbol] ( [symbol] ; θ)= [symbol] _{Simple} ( [symbol] ; θ), there is θ*( [symbol] )=argmin_{θ} [symbol] ₛᵢₘₚₗₑ ( [symbol] ; θ) and the model output function is set to be [symbol] ( [symbol] ; θ)= [symbol] ( [symbol] ; θ)= [symbol] _{Simple}( [symbol] , θ).

In this particular configuration, when it computes the attribution score of TRAK in Eq. 6, the weighting terms

$${TRAK}_{s}^{} = \frac{\partial ℒ}{\partial ℱ} = I$$

become identity matrices, and the function ϕ^{s} is constructed as ϕ^{s}( [symbol] )= [symbol] ₛ^{T}∇_{θ} [symbol] _{Simple}( [symbol] , θₛ*).

In some embodiments, it considers TRAK with ϕ^{s}( [symbol] )= [symbol] ₛ^{T}∇_{θ} [symbol] _{Simple}( [symbol] , θₛ*) as a suitable approach for attributing DDPMs. This is particularly applicable where both [symbol] and [symbol] are [symbol] _{Simple}.

In some embodiments, the attribution is calculated by a D-TRAK. It replaces ϕₛ( [symbol] ) with alternative functions can result in higher values of LDS. Specifically, the formula is

$${τ}_{D - TRAK} ( x , 𝒟 ) = [ \frac{1}{S} {\sum }_{s = 1}^{S} {{ϕ}^{s} ( x )}^{T} {( {{Φ}_{D - TRAK}^{s}}^{T} {Φ}_{D - TRAK}^{s} )}^{- 1} {{Φ}_{D - TRAK}^{s}}^{T} ] , \qquad ( 7 )$$

where Φ_{D-TRAK}^{s}=[ϕ^{s}( [symbol] ²); . . . ; ϕ^{s}( [symbol] ^{N})]^{T} are the projected gradient matrices. D-TRAK allows ϕ^{s} to be constructed from alternative functions, rather than relying on [symbol] as ϕ^{s}( [symbol] )= [symbol] ₛ^{T}∇_{θ} [symbol] ( [symbol] ; θₛ*). The weighting terms are eliminated (i.e., [symbol] _{D-TRAK}^{s}=I) under the assumption that [symbol] and [symbol] are the same. In addition to [symbol] _{Simple} and [symbol] _{ELBO}, alternative functions of [symbol] _{Square}, [symbol] _{Avg}, and [symbol] ₚ₋ₙₒᵣₘ are defined to be the constructing ϕ^{s} in D-TRAK, formulated as

$${ℒ}_{Square} ( x , θ ) = {𝔼}_{t , ϵ} [ {‖ {ϵ}_{θ} ( {x}_{t} , t ) ‖}_{2}^{2} ] ; {ℒ}_{Avg} ( x , θ ) = {𝔼}_{t , ϵ} [ Avg ( {ϵ}_{θ} ( {x}_{t} , t ) ) ] ;$$

$${ℒ}_{p - norm} ( x , θ ) = {𝔼}_{t , ϵ} [ {‖ {ϵ}_{θ} ( {x}_{t} , t ) ‖}_{p} ] ,$$

where

$${x}_{t} = \sqrt{{\overline{α}}_{t}} x + \sqrt{1 - {\overline{α}}_{t}} ϵ$$

and Avg(⋅): [symbol] → [symbol] is the average pooling operation. It instantiates p=1, 2, ∞ for [symbol] ₚ₋ₙₒᵣₘ.
Interpolartion Between [symbol] _{Simple} and [symbol] _{Square}

It is noteworthy that several alternative functions, namely [symbol] _{Square}, [symbol] _{Avg}, [symbol] ₂₋ₙₒᵣₘ, and [symbol] ₁₋ₙₒᵣₘ, consistently outperform the seemingly reasonable choice of [symbol] _{Simple} To take a closer look on how these phenomena occur, [symbol] _{Square} is taken as an object of study, and expand the gradients of [symbol] _{Simple} and [symbol] _{Square} as

$${∇}_{θ} {ℒ}_{Simple} = {t , ϵ}_{} [ 2 \cdot {( {ϵ}_{0} - ϵ )}^{T} {∇}_{θ} {ϵ}_{θ} ] and {∇}_{θ} {ℒ}_{Square} = {t , ϵ}_{} [ 2 \cdot {ϵ}_{θ}^{T} {∇}_{θ} {ϵ}_{θ} ] , \qquad ( 8 )$$

where the dependence on [symbol] and ϵ is omitted for the simplicity of notations. It is found that ∇_{θ} [symbol] _{Simple} and ∇_{θ} [symbol] _{Square} share the same term of ∇_{θ}ϵ_{θ}, and the difference is that they product ∇_{θ}ϵ_{θ} with 2·(ϵ_{θ}−ϵ)^{T} and 2·ϵ_{θ}^{T}, respectively. It is deduced that the information of ∇_{θ}ϵ_{θ} is better retained in the norm-based losses. Hence, it performs interpolation on these two loss functions and subsequently utilize the resulting function to construct ϕ^{s} in D-TRAK:

$${ϕ}^{s} ( x ) {𝒫}_{s}^{T} {∇}_{θ} [ η {ℒ}_{Square} + ( 1 - η ) ( {ℒ}_{Simple} - {L}_{Square} ) ] ( x , θ \text{?} ) E \text{?} [ 2 \cdot {( η {ϵ}_{θ} - ( 1 - η ) ϵ )}^{T} {∇}_{θ} {ϵ}_{θ} ] ,$$

$$\text{?} \text{indicates text missing or illegible when filed}$$

where η∈[0, 1] is the interpolation hyperparameter. When η=0.5, there is

$${ϕ}^{s} ( x ) = \frac{1}{2} {𝒫}_{s}^{T} {∇}_{θ} {ℒ}_{Simple}$$

corresponding to TRAK (the constant factor ½ does not affect LDS); when η=1, there is ϕ^{s}(x)= [symbol] _{θ} [symbol] _{Square} corresponding to D-TRAK ( [symbol] _{Square}). TRAK (i.e., η=0.5) has the poorest performance compared to other interpolations. Moreover, as the value of η diverges further from 0.5, approaching either 0 or 1, the corresponding LDS values increase.

### EXPERIMENTS

### Datasets

The input images are from three datasets including CIFAR (32×32), CelebA (64×64), and ArtBench (256×256).

In some embodiments, CIFAR (32×32) data set is used. The CIFAR-10 dataset comprises 50,000 training samples. It randomly samples 1,000 validation samples from CIFAR-10's test set for LDS evaluation. To reduce computation, a CIFAR-2 dataset is also constructed as a subset of CIFAR-10, which consists of 5,000 training samples randomly sampled from CIFAR-10's training samples corresponding to the “automobile” and “horse” classes, and 1,000 validation samples randomly sampled from CIFAR-10's test set corresponding to the same two classes.

On CIFAR, the model architecture has 35.7 M parameters (i.e., d=35.7×10⁶ for θ∈ [symbol] ^{d}). The maximum timestep is T=1000, and the linear variance schedule for the forward diffusion process is β₁=10⁻⁴ to β_{T}=0.02. The dropout rate is set to be 0.1, employ the AdamW optimizer with weight decay of 10⁻⁶, and augment the data with random horizontal flips. A DDPM is trained for 200 epochs with a 128 batch size, using a cosine annealing learning rate schedule with a 0.1 fraction warmup and an initial learning rate of 10⁻⁴. During inference, new images are generated utilizing the 50-step DDIM solver.

In some embodiments, CelebA (64×64) data set is used. It samples a subset of 5,000 training samples and 1,000 validation samples from the original training set and test set of CelebA, respectively, and first center crop the images to 140×140 and then resize them to 64×64.

On CelebA, it uses an unconditional DDPM implementation that is similar to the one used for CIFAR after being adapted to 64×64 resolution by slightly modifying the U-Net architecture, which has 118.8 M parameters. Other hyper-parameters are identical to those employed on CIFAR.

In some embodiments, ArtBench (256×256) data set is used. ArtBench is a dataset for artwork generation. It includes 60,000 artwork images for 10 distinct artistic styles, with 5,000 training images and 1,000 testing images per style. ArtBench-2 is also constructed as a subset of ArtBench, consisting of 5,000 training/1,000 validation samples sampled from 10,000 training/2,000 test samples of the “post-impressionism” and “ukiyo-e” classes. The method is tested also test on ArtBench-5 as a subset of ArtBench, consisting of 12,500 training/1,000 validation samples sampled from 25,000 training/5,000 test samples of the “post-impressionism”, “ukiyo-e”, “romanticism”, “renaissance” and “baroque” classes.

On ArtBench, it fine-tunes the Stable Diffusion model using LoRA with the rank set to 128, which consists of 25.5 M parameters. To fit the resolution ratio of ArtBench, it uses a Stable Diffusion checkpoint that has been adapted from 512×512 to 256×256 resolution. The model is trained in a class-conditional manner where the textual prompt is simply set as “a {class} painting” such as “a romanticism painting”. It also sets the dropout rate to 0.1, employ the AdamW optimizer with weight decay of 10⁻⁶, and augment the data with random horizontal flips. The model is trained for 100 epochs under a batch size of 64, using a cosine annealing learning rate schedule with 0.1 fraction warmup and an initial learning rate of 3×10⁻⁴. At the inference phase, new images are sampled using the 50-step DDIM solver and a guidance scale of 7.5.

In addition to the 1,000 held-out validation samples, a set of 1,000 generated images are created for each of the aforementioned datasets. Notably, calculating LDS necessitates retraining a large number of models, which constitutes the majority of the computational cost. In contrast, several attribution methods, such as TRAK and D-TRAK, are computationally efficient and scalable to larger datasets.

### Evaluating LDS for Attribution Methods

To conduct the LDS evaluation, it samples M=64 different random subsets of the training set [symbol] , and trains three models with different random seeds on each one of these subsets. Each subset sampled to 50% of the size of the training set, that is, it sets α=0.5. It then computes the linear datamodeling score for each sample of interest as the Spearman rank correlation between the model output and the attribution-based output prediction of the model output as described in Eq. 3. Especially, when computing [symbol] _{Simple}( [symbol] ; θ) as described in Eq.2 or any sample of interest from either the validation set or generation set, it considers all the 1000 timesteps selected to be evenly spaced within the interval [1, T] to approximate the expectation [symbol] ₜ. For each timestep, it samples three standard Gaussian noises δ˜ [symbol] (ϵ|0, I) to approximate the expectation [symbol] _{ϵ}. In some embodiment, the LDS is averaged across samples of interest from the validation set and generation set respectively.

FIG. 5a is a table of Latent Diffusion Score (LDS) values using the data attribution method according to an embodiment of the invention.

The table shows the LDS (%) values on CIFAR-2 (a subset consisting of two classes from CIFAR-10) with different constructions of ϕ^{s}( [symbol] ). All the values of LDS are calculated with [symbol] = [symbol] = [symbol] _{Simple}, and the model is a DDPM with T=1000. LDS values are computed on both the validation set (original test images) and the generation set (newly generated images) with respect to the training samples. Regarding the trade-off between computational demand and efficiency, different numbers of timesteps are considered (e.g., 10, 100, and 1000) sampled from t˜ [symbol] ([1, T]) to approximate the expectation of [symbol] ₜ, where these timesteps are selected to be evenly spaced within the interval [1, T] (by the arange operation). For each sampled timestep, it samples one standard Gaussian noise ϵ˜ [symbol] (ϵ|0, I) to approximate the expectation [symbol] _{ϵ}. The projection dimension of each [symbol] ₛ is k=4096. While ϕ²( [symbol] )= [symbol] ₛ^{T}∇_{θ} [symbol] _{Simple}( [symbol] , θₛ*) should be a reasonable design choice for attributing DDPMs, it is counter-intuitive to observe that using ϕ^{s} constructed by [symbol] _{Square}, [symbol] _{Avg}, [symbol] ₂₋ₙₒᵣₘ, and [symbol] ₁₋ₙₒᵣₘ consistently achieve higher values of LDS. As can be seen from table, D-TRAK constructed from [symbol] _{Square}, [symbol] _{Avg}, [symbol] ₂₋ₙₒᵣₘ, and [symbol] ₁₋ₙₒᵣₘ consistently outperform TRAK by a large margin.

FIG. 5b is the LDS (%) values on the generation set of CIFAR-2 using checkpoints of different epochs using the data attribution method according to an embodiment of the invention. It selects 10, 100, and 1000 timesteps evenly spaced within the interval [1, T] to approximate [symbol] ₜ. For each selected timestep, it samples one standard Gaussian noise to approximate [symbol] _{ϵ}. The value of k is set as k=32768. The plot 510 is when the timesteps is 10. The plot 520 is when the timesteps is 100. The plot 530 is when the timesteps is 1000.

As shown in FIG. 5b, for D-TRAK, the best LDS scores are obtained at the final checkpoint. However, for TRAK, using the final checkpoint is not the best choice. Finding which checkpoint yields the best LDS score requires computing the attributions for many times, which means much more computational cost. In practice, it might also only get access to the final model.

In summary, when computing gradients, the final model checkpoint is used as default. 10 and 100 timesteps are selected to be evenly spaced within the interval [1, T]. For example, the selected timesteps are {1, 101, 201, . . . , 901} when the number of timesteps is 10. For each timestep, it samples one standard Gaussian noise. The projection dimension is k=32768.

### Counterfactual Evaluation

To evaluate the faithfulness of D-TRAK more intuitively, it measures the pixel-wise [symbol] ₂-distance and CLIP cosine similarity on CIFAR-2, CelebA, and ArtBench-2 datasets. These measurements are taken between images generated by the models trained both before and after excluding the top-1000 positive influencers, as identified by different attribution methods. For both D-TRAK and TRAK, it considers 100 timesteps, samples one standard Gaussian noise, and sets k=32768. A control baseline called Random is considered, which randomly removes 1000 training samples before retraining.

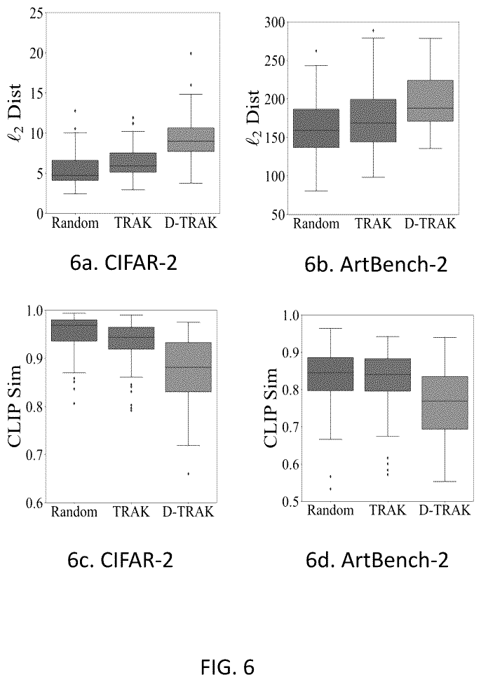

FIG. 6 is the boxplots of counterfactual evaluation on CIFAR-2 and ArtBench-2 using the data attribution method according to an embodiment of the invention. It quantifies the impact of removing the 1,000 highest-scoring training samples and re-training according to Random, TRAK, and D-TRAK. The pixel-wise [symbol] ₂-distance and CLIP cosine similarity between 60 synthesized samples are measured and corresponding images generated by the re-trained models when sampling from the same random seed.

When examining the median pixel-wise [symbol] ₂ distance resulting from removing-and-retraining, D-TRAK yields 15.07, in contrast to TRAK's values of 11.02. A reverse trend is observed when evaluating the median CLIP cosine similarity, where D-TRAK obtains lower similarities of 0.896, which are notably lower than TRAK's 0.942.

The counterfactual evaluation of D-TRAK against TRAK, as presented in FIG. 6, demonstrates that D-TRAK can better identify influential images that have a larger impact on the generated images. As shown in FIG. 6, when examining the median pixel-wise [symbol] ₂ distance resulting from removing-and-retraining, D-TRAK yields 8.97, 15.07, and 187.61 for CIFAR-2, and ArtBench-2, respectively, in contrast to TRAK's values of 5.90 and 168.37. D-TRAK obtains median similarities of 0.881 and 0.769 for the above three datasets respectively, which are notably lower than TRAK's values of 0.943 and 0.840, highlighting the effectiveness of the D-TRAK method.

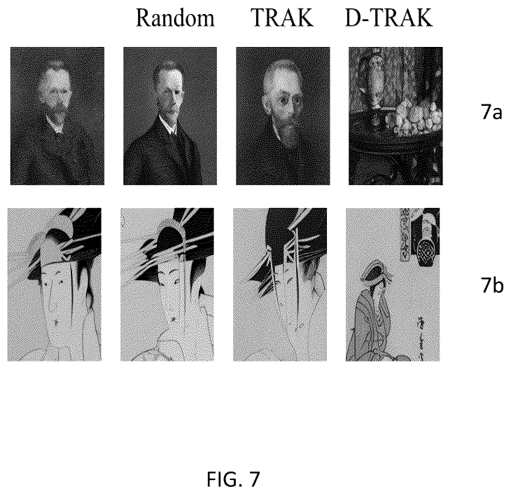

FIG. 7 is the counterfactual visualization on (7a, 7b) ArtBench-2 using the data attribution method according to an embodiment of the invention.

In the context of ArtBench-2 datasets, it compares the original generated samples to those generated from the same random seed with the models trained after the exclusion of the top 1,000 positive influencers identified by different attribution methods including Random, TRAK, and D-TRAK. For both D-TRAK and TRAK, it considers 100 timesteps selected to be evenly spaced within the interval [1, T], samples one standard Gaussian noise, and sets [symbol] =32768 when computing the gradients.

As shown in FIG. 7, the results suggest that the method D-TRAK can better identify influential images that have a significant impact on the target image. Take FIG. 7a as an example, the model retrained after removing training samples based on Random and TRAK still generates a human face image, while the one corresponding to D-TRAK generates an image looks similar to a table.

In some embodiments, it classifies the training samples that have a positive influence score as proponents and samples that have a negative value of influence score as opponents. For samples of interest, the training samples corresponding to the most positive and negative attribution scores are visualized. It is observed that D-TRAK consistently finds proponents visually more similar to the target samples.

In some embodiments, the training samples that have the highest self-influence scores on CIFAR-2 and ArtBench-2 are also visualized. The self-influence of [symbol] ⁿ is computed as τ_{D-TRAK}( [symbol] ⁿ, [symbol] )ₙ. When computing the self-influence scores, it considers 100 timesteps selected to be evenly spaced within the interval [1, T], and set [symbol] =32768. The identified highly self-influenced samples usually look atypical or unique, while low self-influence ones have similar samples in the training set. Especially, on CIFAR-2, highly self-influenced samples are visually high-contrast.

Aspects of the disclosed invention can include one or more of the following, including variations thereof:

Aspect 1. A method of identifying an influential training image in a diffusion model for image generation, comprising the steps of: training the diffusion model using a set of training images; generating one or more output images using the trained diffusion model; computing a gradient matrix for each image in the set of training images; calculating an importance score for the each image in the set of training images based on the computed gradient matrix, wherein the importance score indicates an importance of the set of training images to the one or more output image; and identifying one or more of the training images as the influential training image when the importance score exceeds a predetermined threshold.

Aspect 2. The method of Aspect 1, wherein the importance score is τ_{D-TRAK}, and is calculated based on the equation of

$${τ}_{D − TRAK} ( x , 𝒟 ) = [ \frac{1}{S} {\sum }_{S = 1}^{S} {{ϕ}^{s} ( x )}^{T} {( {{Φ}_{D − TRAK}^{s}}^{T} {Φ}_{D − TRAK}^{s} )}^{− 1} {{Φ}_{D - TRAK}^{s}}^{T} ]$$

wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}^{s}=[ϕ^{s}(x¹); . . . ; ϕ^{s}(x^{N})]^{T}, which is the gradient matrix.

Aspect 3. The method of any of Aspects 1 to 2, wherein ϕ^{s}( [symbol] )=∇_{θ} [symbol] ( [symbol] , θₛ*), and function of [symbol] comprising any one of [symbol] _{Square}, [symbol] _{Avg} or [symbol] ₚ₋ₙₒᵣₘ, wherein:

$${ℒ}_{s q u a r e} ( x , θ ) = {E}_{t , ϵ} , [ {‖ {ϵ}_{θ} ( {x}_{t} , t ) ‖}_{2}^{2} ] ;$$

$${ℒ}_{Avg} ( x , θ ) = {E}_{t , ϵ} , [ Avg ( {ϵ}_{θ} ( {x}_{t} , t ) ) ] ;$$

$${ℒ}_{p - n o r m} ( x , θ ) = {E}_{t , ϵ} , [ {‖ {ϵ}_{θ} ( {x}_{t} , t ) ‖}_{p} ] ;$$

wherein

$${x}_{t} = \sqrt{{\overline{α}}_{t}} x + \sqrt{1 - {\overline{α}}_{t}} ,$$

ϵ and Avg is an average pooling operation.

Aspect 4. The method of any of Aspects 1 to 3, wherein the gradient matrix computation is performed at different training data checkpoints.

Aspect 5. The method of any of Aspects 1 to 4, further comprising: identifying training data checkpoints that contributed most to the generated one or more output images.

Aspect 6. The method of any of Aspects 1 to 5, wherein the gradient matrix computation is performed at a final checkpoint.

Aspect 7. The method of any of Aspects 1 to 6, wherein the diffusion model is a Denoising Diffusion Probabilistic Model (DDPM) or a Latent Diffusion Model (LDM).

Aspect 8. The method of any of Aspects 1 to 7, further comprising: ranking the set of training images based on their importance scores to identify most important images.

Aspect 9. The method of Aspects 1 to 8, further comprising a verification step, which comprises: retraining the diffusion model after removing the most important images identified in the ranking process; generating images using the retrained model; and measuring a pixel wise [symbol] ₂ distance or Contrastive Language-Image Pre-training (CLIP) cosine similarity between images generated by the original and retrained models to confirm an influence of the removed most important images.

Aspect 10. The method of any of Aspects 1 to 9, wherein positive importance scores identify proponent images, and negative scores identify opponent images among the set of training images.

Aspect 11. The method of any of Aspects 1 to 10, further comprising: displaying the identified influential image and/or its corresponding importance score.

Aspect 12. The method of any of Aspects 1 to 11, further comprising: removing training images with low importance score, where the low importance score is below the predetermined threshold value; and finetuning or retraining the diffusion model after removing the training images with low importance score.

Aspect 13. The method of any of Aspects 1 to 12, further comprising: regenerating the one or more output image using the retrained diffusion model.

Aspect 14. A system of identifying an influential training image in a diffusion model for image generation, comprising: a processor; a memory in electronic communication with the processor; and instructions stored in the memory and executable by the processor to cause the system to: train the diffusion model using a set of training images; generate one or more output images using the trained diffusion model; compute a gradient matrix for each image in the set of training images; calculate an importance score for the each image in the set of training images based on the computed gradient matrix, wherein the importance score indicates an importance of the set of training images to the one or more output image; and identify one or more of the training images as the influential training image when the importance score exceeds a predetermined threshold.

Aspect 15. The system of Aspect 14, wherein the importance score is τ_{D-TRAK}, and is calculated based on the equation of

$${τ}_{D - TRAK} ( x , 𝒟 ) = [ \frac{1}{S} {\sum }_{S = 1}^{S} {{ϕ}^{s} ( x )}^{T} {( {{Φ}_{D − TRAK}^{s}}^{T} {Φ}_{D − TRAK}^{s} )}^{− 1} {{Φ}_{D - TRAK}^{s}}^{T} ]$$

wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}^{s}=[ϕ^{s}(x¹); . . . ; ϕ^{s}(x^{N})]^{T}, which is the gradient matrix.

Aspect 16. The system of any of Aspects 14 to 15, wherein ϕ^{s}( [symbol] )=∇_{θ} [symbol] ( [symbol] , θₛ*), and function of [symbol] comprising any of [symbol] _{Square}, [symbol] _{Avg} or [symbol] ₚ₋ₙₒᵣₘ, wherein:

$${ℒ}_{s q u a r e} ( x , θ ) = {E}_{t , ϵ} , [ {‖ {ϵ}_{θ} ( {x}_{t} , t ) ‖}_{2}^{2} ] ;$$

$${ℒ}_{Avg} ( x , θ ) = {E}_{t , ϵ} , [ Avg ( {ϵ}_{θ} ( {x}_{t} , t ) ) ] ;$$

$${ℒ}_{p - n o r m} ( x , θ ) = {E}_{t , ϵ} , [ {‖ {ϵ}_{θ} ( {x}_{t} , t ) ‖}_{p} ] ;$$

wherein

$${x}_{t} = \sqrt{{\overline{α}}_{t}} x + \sqrt{1 - {\overline{α}}_{t}} ,$$

ϵ and Avg is an average pooling operation.

Aspect 17. The system any of Aspects 14 to 16, wherein the gradient matrix computation is performed at a final checkpoint.

Aspect 18. The system of any of Aspects 14 to 17, further comprising displaying the identified influential training image and/or its corresponding influence score.

Aspect 19. An apparatus of identifying an influential training image in a diffusion model for image generation, comprising: means for training the diffusion model using a set of training images; means for generating one or more output images using the trained diffusion model; means for computing a gradient matrix for each image in the set of training images; means for calculating an importance score for the each image in the set of training images based on the computed gradient matrix, wherein the importance score indicates an importance of the set of training images to the one or more output image; and means for identifying one or more of the training images as the influential training image when the importance score exceeds a predetermined threshold.

Aspect 20. A computer-readable storage medium, on which a computer program is stored, wherein the computer program, when executed in a computer, causes the computer to perform operations for: training the diffusion model using a set of training images; generating one or more output images using the trained diffusion model; computing a gradient matrix for each image in the set of training images; calculating an importance score for the each image in the set of training images based on the computed gradient matrix, wherein the importance score indicates an importance of the set of training images to the one or more output image; and identifying one or more of the training images as the influential training image when the importance score exceeds a predetermined threshold.

For the current invention, any suitable programming language can be used to implement the routines of particular embodiments including C, C++, Java, assembly language, etc. Different programming techniques can be employed such as procedural or object oriented. The routines can execute on a single processing device or multiple processors.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

What is claimed is:

1. A method of identifying an influential training image in a diffusion model for image generation, comprising the steps of:
training the diffusion model using a set of training images;
generating one or more output images using the trained diffusion model;
computing a gradient matrix for each image in the set of training images;
calculating an importance score for the each image in the set of training images based on the computed gradient matrix, wherein the importance score indicates an importance of the set of training images to the one or more output image; and
identifying one or more of the training images as the influential training image when the importance score exceeds a predetermined threshold.

2. The method of claim 1, wherein the importance score is τ_{D-TRAK}, and is calculated based on the equation of
$${τ}_{D - TRAK} ( x , 𝒟 ) = [ \frac{1}{S} {\sum }_{S = 1}^{S} {{ϕ}^{s} ( x )}^{T} {( {{Φ}_{D − TRAK}^{s}}^{T} {Φ}_{D − TRAK}^{s} )}^{− 1} {{Φ}_{D - TRAK}^{s}}^{T} ] .$$
wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}^{s}=[ϕ^{s}(x¹); . . . ; ϕ^{s}(x^{N})]^{T}, which is the gradient matrix.

3. The method of claim 2, wherein ϕ^{s}(x)=∇_{θ} [symbol] (x, θₛ*), and function of [symbol] comprising any one of [symbol] _{Square}, [symbol] _{Avg} or [symbol] ₚ₋ₙₒᵣₘ, wherein:
$${ℒ}_{s q u a r e} ( x , θ ) = {E}_{t , ϵ} , [ {‖ {ϵ}_{θ} ( {x}_{t} , t ) ‖}_{2}^{2} ] ;$$
$${ℒ}_{Avg} ( x , θ ) = {E}_{t , ϵ} , [ Avg ( {ϵ}_{θ} ( {x}_{t} , t ) ) ] ;$$
$${ℒ}_{p - n o r m} ( x , θ ) = {E}_{t , ϵ} , [ {‖ {ϵ}_{θ} ( {x}_{t} , t ) ‖}_{p} ] ; .$$
wherein
$${x}_{t} = \sqrt{{\overline{α}}_{t}} x + \sqrt{1 - {\overline{α}}_{t}} , .$$
ϵ and Avg is an average pooling operation.

4. The method of claim 1, wherein the gradient matrix computation is performed at different training data checkpoints.

5. The method of claim 1, further comprising:
identifying training data checkpoints that contributed most to the generated one or more output images.

6. The method of claim 1, wherein the gradient matrix computation is performed at a final checkpoint.

7. The method of claim 1, wherein the diffusion model is a Denoising Diffusion Probabilistic Model (DDPM) or a Latent Diffusion Model (LDM).

8. The method of claim 1, further comprising ranking the set of training images based on their importance scores to identify most important images.

9. The method of claim 8, further comprising a verification step, which comprises:
retraining the diffusion model after removing the most important images identified in the ranking process;
generating images using the retrained model; and
measuring a pixel wise [symbol] ₂ distance or Contrastive Language-Image Pre-training (CLIP) cosine similarity between images generated by the original and retrained models to confirm an influence of the removed most important images.

10. The method of claim 1, wherein positive importance scores identify proponent images, and negative scores identify opponent images among the set of training images.

11. The method of claim 1, further comprising:
displaying the identified influential image and/or its corresponding importance score.

12. The method of claim 1, further comprising:
removing training images with low importance score, where the low importance score is below the predetermined threshold value; and
finetuning or retraining the diffusion model after removing the training images with low importance score.

13. The method of claim 12, further comprising:
regenerating the one or more output image using the retrained diffusion model.

14. A system of identifying an influential training image in a diffusion model for image generation, comprising:
a processor;
a memory in electronic communication with the processor; and
instructions stored in the memory and executable by the processor to cause the system to:
train the diffusion model using a set of training images;
generate one or more output images using the trained diffusion model;
compute a gradient matrix for each image in the set of training images;
calculate an importance score for the each image in the set of training images based on the computed gradient matrix, wherein the importance score indicates an importance of the set of training images to the one or more output image; and
identify one or more of the training images as the influential training image when the importance score exceeds a predetermined threshold.

15. The system of claim 14, wherein the importance score is τ_{D-TRAK}, and is calculated based on the equation of
$${τ}_{D - TRAK} ( x , 𝒟 ) = [ \frac{1}{S} {\sum }_{S = 1}^{S} {{ϕ}^{s} ( x )}^{T} {( {{Φ}_{D − TRAK}^{s}}^{T} {Φ}_{D − TRAK}^{s} )}^{− 1} {{Φ}_{D - TRAK}^{s}}^{T} ] .$$
wherein the score τ_{D-TRAK}, represents how a training sample xⁿ∈ [symbol] affects the diffusion model for the image generation, a total of S subsets are initially sampled from the training dataset [symbol] , wherein
Φ_{D-TRAK}^{s}=[ϕ^{s}(x¹); . . . ; ϕ^{s}(x^{N})]^{T}, which is the gradient matrix.

16. The system of claim 15, wherein ϕ^{s}(x)=∇_{θ} [symbol] (x, θₛ*), and function of [symbol] comprising any of [symbol] _{Square}, [symbol] _{Avg} or [symbol] ₚ₋ₙₒᵣₘ, wherein:
$${ℒ}_{s q u a r e} ( x , θ ) = {E}_{t , ϵ} , [ {‖ {ϵ}_{θ} ( {x}_{t} , t ) ‖}_{2}^{2} ] ;$$
$${ℒ}_{Avg} ( x , θ ) = {E}_{t , ϵ} , [ Avg ( {ϵ}_{θ} ( {x}_{t} , t ) ) ] ;$$
$${ℒ}_{p - n o r m} ( x , θ ) = {E}_{t , ϵ} , [ {‖ {ϵ}_{θ} ( {x}_{t} , t ) ‖}_{p} ] ; .$$
wherein
$${x}_{t} = \sqrt{{\overline{α}}_{t}} x + \sqrt{1 - {\overline{α}}_{t}} , .$$
ϵ and Avg is an average pooling operation.

17. The system of claim 14, wherein the gradient matrix computation is performed at a final checkpoint.

18. The system of claim 14, further comprising displaying the identified influential training image and/or its corresponding influence score.

19. A computer-readable storage medium, on which a computer program is stored, wherein the computer program, when executed in a computer, causes the computer to perform operations for:
training the diffusion model using a set of training images;
generating one or more output images using the trained diffusion model;
computing a gradient matrix for each image in the set of training images;
calculating an importance score for the each image in the set of training images based on the computed gradient matrix, wherein the importance score indicates an importance of the set of training images to the one or more output image; and
identifying one or more of the training images as the influential training image when the importance score exceeds a predetermined threshold.

20. The computer-readable storage medium of claim 19, wherein the importance score is τ_{D-TRAK}, and is calculated based on the equation of
$${τ}_{D - TRAK} ( x , 𝒟 ) = [ \frac{1}{S} {\sum }_{S = 1}^{S} {{ϕ}^{s} ( x )}^{T} {( {{Φ}_{D − TRAK}^{s}}^{T} {Φ}_{D − TRAK}^{s} )}^{− 1} {{Φ}_{D - TRAK}^{s}}^{T} ] .$$
wherein the score τ_{D-TRAK}, represents how a training sample xⁿ∈ [symbol] affects the diffusion model for the image generation, a total of S subsets are initially sampled from the training dataset [symbol] , wherein Φ_{D-TRAK}^{s}=[ϕ^{s}(x¹); . . . ; ϕ^{s}(x^{N})]^{T}, which is the gradient matrix.
